(19) United States
(12) Patent Application Publication
(10) Pub. No.: US 2016/0018255 A1
(43) Pub. Date: Jan. 21, 2016

(54) WIRELESS KITCHEN WEIGHING SCALE

(71) Applicant: Michael Fang, West Covina, CA (US)

(72) Inventor: Michael Fang, West Covina, CA (US)

(21) Appl. No.: 14/800,688

(22) Filed: Jul. 15, 2015

Related U.S. Application Data
(60) Provisional application No. 62/024,800, filed on Jul. 15, 2014.

(51) Int. Cl. G01G 23/37; H04B 1/40; H04W 4/00

(52) U.S. Cl. CPC G01G 23/3742; H04W 4/008; H04B 1/40

(57) ABSTRACT

A weighing scale may include a weighing platform, a weight measurement module, a wireless data communication module, a weight data processing and transmitting system, a display screen, and a control panel. In one embodiment, the weighing device can be a regular weighing scale, and in another embodiment, the weighing scale can be a wireless weighing scale which can store and transmit data generated by the weighing scale to external electronic devices or receive and store data coming from external electronic devices. In one embodiment, the wireless data communication module can be used to transmit data to or receive data from distant electronic devices via the wireless network data transmission system and Internet. In another embodiment, the wireless data communication module can be used to retrieve data from the onboard memory module and transmit them to distant electronic devices via the wireless network data transmission system and Internet.

### CROSS-REFERENCE TO RELATED APPLICATIONS

This application claims priority under 35 U.S.C. §119 (e) to U.S. Provisional Patent Application Ser. No. 62/024,800 filed on Jul. 15, 2014, the entire contents of which are hereby incorporated by reference.

### FIELD OF THE INVENTION

The present invention relates generally to a household weighing device, and more particularly to an electronic kitchen scale that can store and transmit data via a wireless interface.

### BACKGROUND OF THE INVENTION

Although electronic scales have gradually gained their popularity as an appliance in modern kitchens, they generally lack the capability of storing and sharing data. Most of them are also unable to communicate with external electronic devices for further data processing purposes. Data storage and processing can be a necessary valuable function especially for the purpose of weight watching, healthy diet monitoring, and efficient grocery inventory managing. It is even desirable that a wireless weighing scale can be equipped with an Internet communication function in order to transmit data generated by the weighing scale to nearby or distant external electronic devices or to receive and store data coming from nearby or distant external devices.

Chinese Pat. No.: CN 202757684 to Chen et al. discloses an electronic kitchen scale with a wireless Bluetooth data transmitting function. More particularly, the electronic kitchen scale with the wireless Bluetooth data transmitting function comprises an upper housing, a lower housing, a sensor, touch keys, a weighing tray, a scale LCD, a power supply device, a Bluetooth module, and a circuit board. Even though a Bluetooth apparatus is deployed to transmit data in Chen's disclosure, the kitchen scale does not contain any specified memory module to store data either generated directly by the kitchen scale or uploaded from other external resources. Moreover, data generated by the kitchen scale cannot be accessed by external electronic devices.

European Pat. No.: DE 102012205669 to Hoeck et al. discloses a digital weighing device used in kitchens for weighing the weight of food product and it contains a cradle element that is coupled with transmitter so that weighing signal is transmitted wirelessly from transmitter to an evaluation device, as shown in FIG. 1. More particularly, the device has a weighing element provided to generate a weighing signal corresponding to a determinable weight. The evaluation device is provided for determining a total weight value of the weighing signal by using the one weighing element. The cradle element is coupled with transmitter so that the weighing signal is transmitted wirelessly from transmitter to the evaluation device. A transmission technology such as Bluetooth and ZigBee is used by transmitter. However, even though the weighing device disclosed by Hoeck can transmit the weighing signal to the evaluation device wirelessly, the weighing device is designed to be a standalone device with no intention of sharing data with other external electronic devices. In addition, the weighing device does not contain any specified memory module to store data either generated directly by the kitchen scale or uploaded from other external resources. Moreover, data generated by the kitchen scale cannot be accessed by external electronic devices.

U.S. Pat. No. 8,330,057 to Sharawi et al. discloses a food calorie counting system, as shown in FIG. 2. More particularly, a calorie counting system that utilizes a container with at least one chamber for holding food materials, sensitive scales integrated into the chambers to weigh the food, and a processor to calculate the number of calories in the food items based on weight, type of food and method of preparation. Although the system disclosed by Sharawi utilizes an external central control unit to process and calculate food calorie and transmit results back to the containers for display, the food calorie counting system is not designed for transmitting data to external devices other than the central control unit. Moreover, data generated from the food calorie counting system cannot be accessed by distant electronic devices.

Chinese Pat. No.: CN 201666812 to Bo discloses an electronic scale with wireless interface. More particularly, the electronic scale comprises a weight data processing and transmitting system weight data processing and transmitting system, a weighing sensor, an LCD display and a key switch, wherein the weighing sensor is connected with an analog-to-digital conversion interface of the weight data processing and transmitting system. The LCD display is connected with a serial port of the weight data processing and transmitting system, and the key switch is connected with one group of IO ports of the weight data processing and transmitting system. The electronic scale also comprises a wireless transceiver and a USB adaptor matched with the wireless transceiver, wherein the wireless transceiver is connected with an SPI interface of the weight data processing and transmitting system, and wireless communication is carried out between the wireless transceiver and the USB adaptor. Although, the electronic scale with the wireless interface disclosed by Bo does not only measure and display weight, but can also wirelessly upload weight data to a computer and an internet server through the wireless communication between the wireless transceiver and the USB adaptor, the electronic scale with the wireless interface is not designed for weighing groceries. In addition, the electronic scale with the wireless interface does not contain any specified memory module to store data either generated directly by the electronic scale or uploaded from other external resources. Since data generated by the electronic scale are not saved in a designated long-term memory module, they cannot be accessed by distant electronic devices. Moreover, the electronic scale is not designed to download data directly from other external resources.

Chinese Pat. No.: CN 201964943 to Xia discloses an electronic weighing machine. More particularly, the weighing machine includes a weight measurement module and WIFI data communication module. Although, like Bo, the electronic weighing machine disclosed by Xia adopts a WIFI wireless network data transmission system, the weighing machine is not designed for weighing groceries. In addition, the weighing machine does not contain any specified memory module to store data generated either directly by the electronic weighing machine or uploaded from other external resources.

Therefore, there remains a need for a new and improved electronic scale to transmit data wirelessly and store data generated either directly by the electronic scale or uploaded from other external resources. It is also desirable to provide an electronic scale that can be accessed by distant electronic devices to retrieve data from or upload data onto the electronic scale for information management to facilitate grocery shopping and cooking activities.

### SUMMARY OF THE INVENTION

It is an object of the present invention to provide an electronic scale to be used in kitchens for weighing groceries.

It is another object of the present invention to provide an electronic scale comprising a wireless network system used in the kitchen for weighing groceries, so that the weighing data can be transmitted to nearby or distant external electronic devices, which can be viewed by the user or can be further processed.

It is a further object of the present invention to provide an electronic scale comprising a wireless network system and an onboard memory module to be used in kitchens for weighing groceries, so that the weighing data can be stored in the present invention.

It is still a further object of the present invention to provide an electronic scale comprising a wireless network system and an onboard memory module, so that the present invention can receive and store data coming from nearby or distant external resources.

It is yet another object of the present invention to provide an electronic scale comprising a wireless network system and an onboard memory module to be used in kitchens, so that data stored in the onboard memory can be managed via nearby or distant electronic devices to facilitate grocery inventory management, nutrition monitoring, and food processing activities.

In one aspect, a wireless weighing device may include a plurality of weight measurement modules, a display screen, a control panel. The wireless weighing device may further include a weight data processing and transmitting system, which includes a weight data receiver, a memory, a weight data processing unit and a user interface controller. In one embodiment, the weight data receiver is communicatively connected with the weight measurement modules to receive the weight data, which can be further transmitted to the weight data processing unit to be further processed. The memory can be used to store the weight data and the user interface controller is operatively communicated with the display screen to display the weight information. In an exemplary embodiment, the weight data processing unit is communicatively and operatively communicated with a wireless data communication module, so the weight data being processed by the weight data processing unit can be transmitted out from the weighing device. In a further embodiment, an external device can also obtain the weight information through the wireless data communication module.

In another aspect, a mobile device can be connected to a communication network to a server, a communication interface, or surfing on the internet to retrieve the contents provided by the server, communication interface, or the internet if certain verification requirements are satisfied. For example, the user can retrieve his or her body check report from a hospital server through his/her cell phone, which can then transmitted such information back to the weighing device through the wireless data communication module to be stored in the memory. So, when next time the salt is used up, the wireless weighing device may suggest the user to purchase a specific kind of salt according to stored body check report, or suggest a daily usage thereof.

### BRIEF DESCRIPTION OF THE DRAWINGS

FIG. 1 illustrates a prior art disclosing an electronic kitchen scale with a wireless Bluetooth data transmitting function.

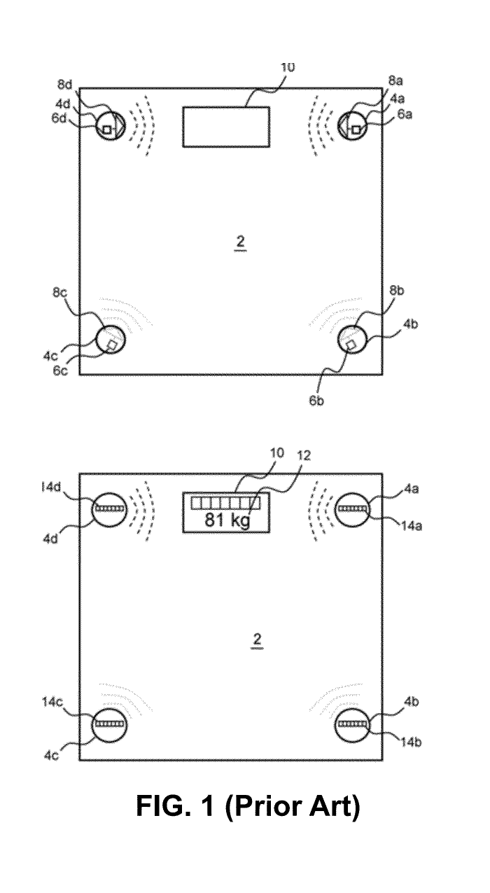

FIG. 2 illustrates a prior art disclosing a digital weighing device used in kitchens for weighing weight of food product, has a cradle element that is coupled with transmitter so that weighing signal is transmitted wirelessly from transmitter to evaluation device.

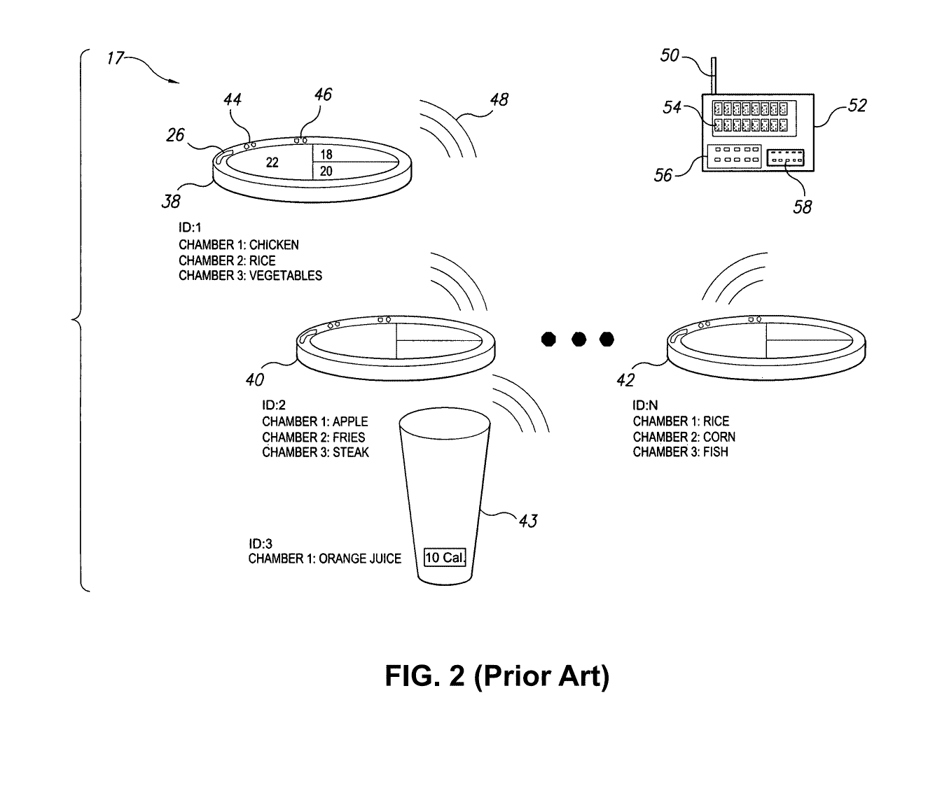

FIG. 3 illustrates a schematic view of a wireless kitchen weighing device in the present invention.

FIG. 4 illustrates block diagram of a weight data processing and transmitting system in the present invention.

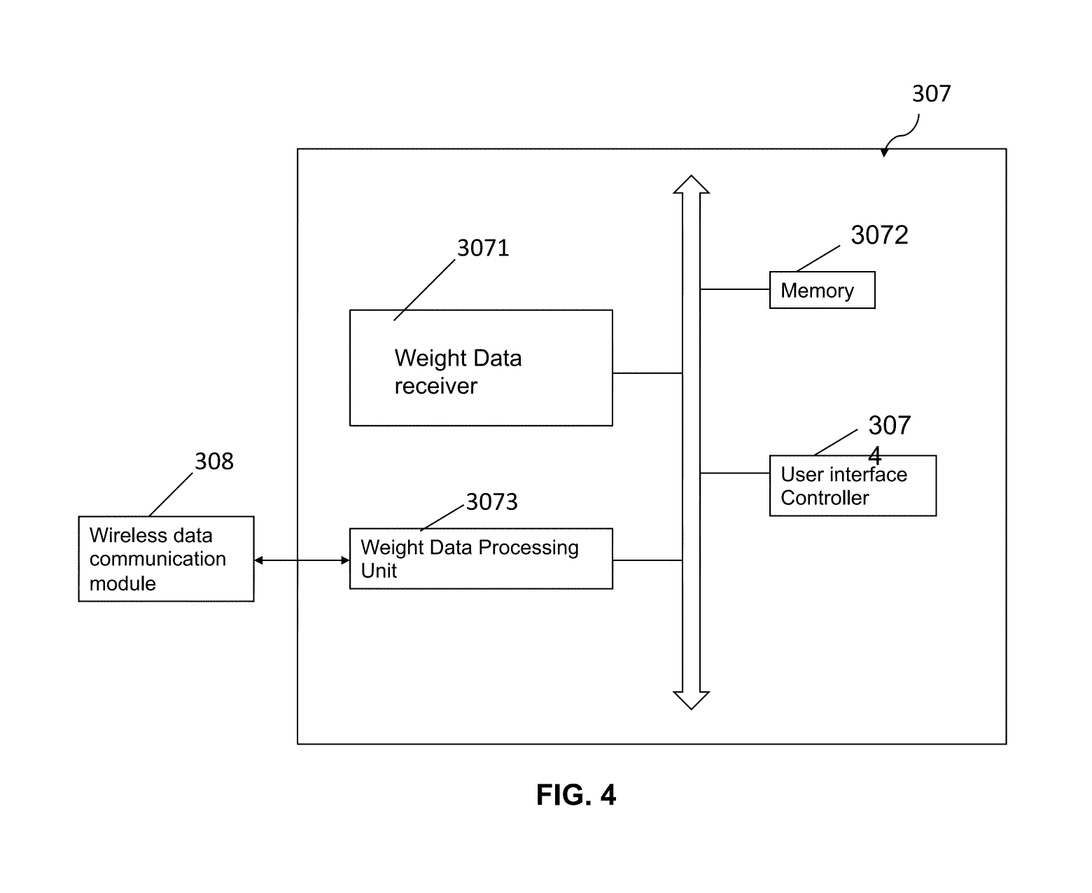

FIG. 5 illustrates block diagram of a wireless data communication module in the present invention.

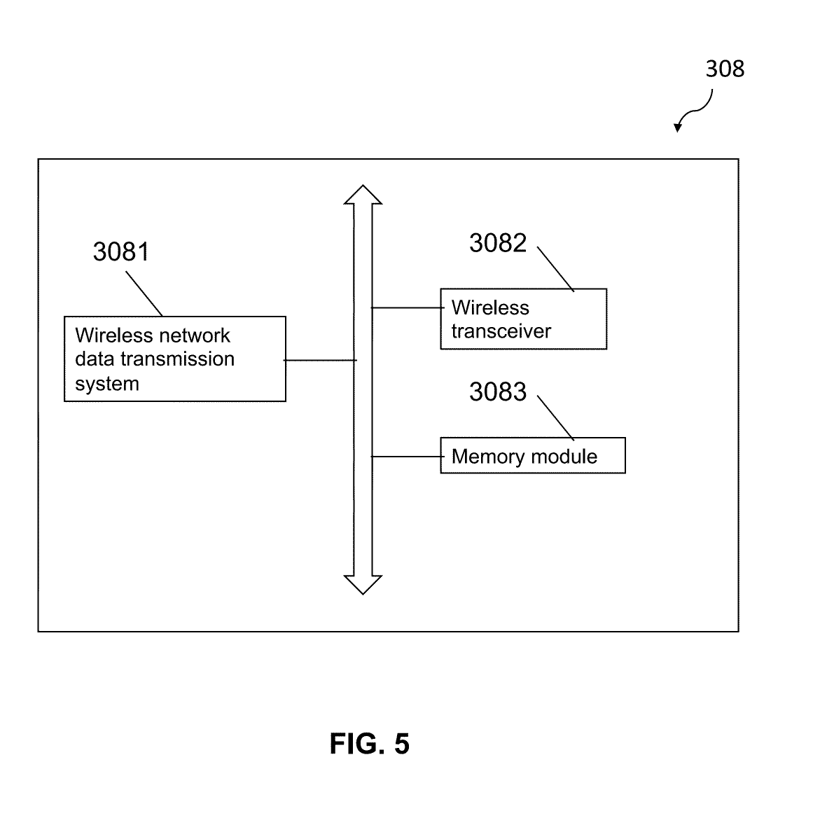

FIG. 6 illustrates an exemplary embodiment in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skills in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

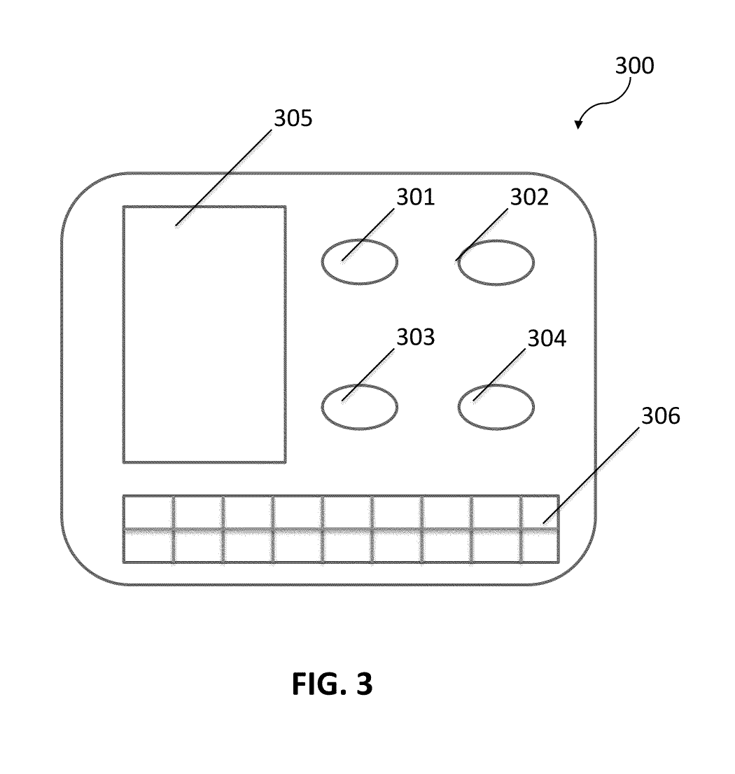

As shown in FIG. 3, a wireless weighing device 300 may include a plurality of weight measurement modules 301-304, a display screen 305, a control panel 306. The wireless weighing device 300 may further include a weight data processing and transmitting system 307, which includes a weight data receiver 3071, a memory 3072, a weight data processing unit 3073 and a user interface controller 3074. In one embodiment, the weight data receiver 3071 is communicatively connected with the weight measurement modules 301-304 to receive the weight data, which can be further transmitted to the weight data processing unit 3073 to be further processed. The memory 3072 can be used to store the weight data and the user interface controller 3074 is operatively communicated with the display screen to display the weight information. In an exemplary embodiment, the weight data processing unit 3073 is communicatively and operatively communicated with a wireless data communication module 308, so the weight data being processed by the weight data processing unit 3073 can be transmitted out from the weighing device 300. In a further embodiment, an external device can also obtain the weight information through the wireless data communication module 308.

In one embodiment, the wireless data communication module 308 may include a wireless network data transmission system 3081, a wireless transceiver 3082, and an onboard memory module 3083. In one embodiment, the wireless data communication module 308 can transmit data to or receive data from nearby electronic devices directly via the wireless transceiver 3082 or indirectly via a router. In an exemplary embodiment, the wireless data communication module 308 can retrieve data from the onboard memory module 3083, or transmit them to nearby electronic devices directly via the wireless transceiver 3081 or indirectly via a router. In another embodiment, the wireless data communication module 308 can download data from nearby electronic devices onto the aforementioned onboard memory module 3083 directly via the wireless transceiver 3081 or indirectly via a router. In a further embodiment, the wireless data communication module 308 can be used to transmit data to or receive data from distant electronic devices via the wireless network data transmission system 3081 and Internet. In yet another embodiment, the wireless data communication module 308 can be used to retrieve data from the onboard memory module 3083 and transmit them to distant electronic devices via the wireless network data transmission system 3081 and Internet. In still a further embodiment, the wireless data communication module 308 can be used to download data from distant electronic devices onto the aforementioned onboard memory module 3083 via the wireless network data transmission system 3081 and internet.

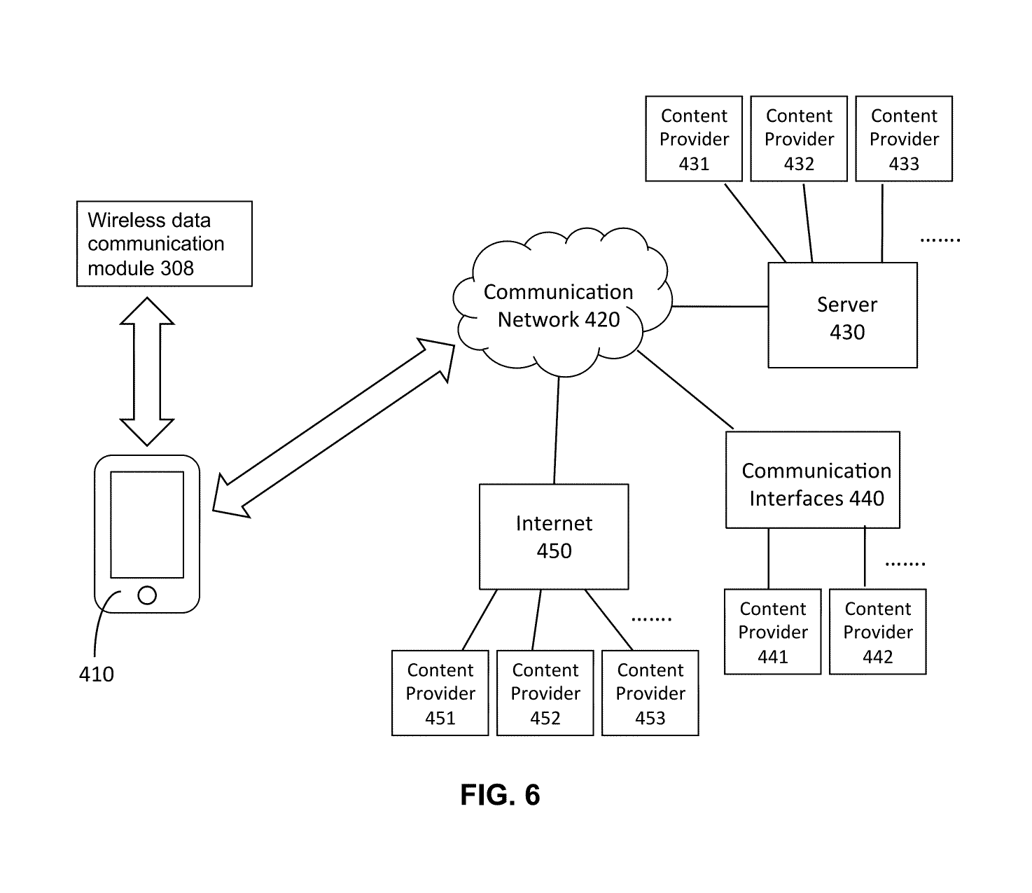

As stated above, the wireless data communication module 308 of the wireless weighing device 300 can be communicatively connected with external devices, such as computers, mobile devices, etc. In another aspect as shown in FIG. 6, a mobile device 410 can be connected to a communication network 420 to a server 430, a communication interface 440, or surfing on the internet 450 to retrieve the contents provided by the server 430, communication interface 440, or the internet 450 if certain verification requirements are satisfied. For example, the user can retrieve his or her body check report from a hospital server through his/her cell phone, which can then transmitted such information back to the weighing device 300 through the wireless data communication module 308 to be stored in the memory. So, when next time the salt is used up, the wireless weighing device may suggest the user to purchase a specific kind of salt according to stored body check report, or suggest a daily usage thereof.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A wireless weighing device comprising a plurality of weight measurement modules, a display screen, a control panel and a weight data processing and transmitting system, which includes a weight data receiver, a memory, a weight data processing unit and a user interface controller,
wherein the weight data receiver is communicatively connected with the weight measurement modules to receive the weight data, which are further transmitted to the weight data processing unit to be further processed; the memory is used to store the weight data, and the user interface controller is operatively communicated with the display screen to display the weight information, wherein the weight data processing unit is communicatively and operatively communicated with a wireless data communication module, so that the weight data being processed by the weight data processing unit is configured to be transmitted out from the weighing device.

2. The wireless weighing device of claim 1, wherein the wireless data communication module includes a wireless network data transmission system, a wireless transceiver, and an onboard memory module.
